(19) United States
(12) Patent Application Publication
(10) Pub. No.: US 2022/0386526 A1
(43) Pub. Date: Dec. 8, 2022

(54) POWERED GARDEN TOOLS

(71) Applicant: TECHTRONIC CORDLESS GP, Anderson, SC (US)

(72) Inventors: Hei Man Lee, Kawi Chung (CN); Li Feng Wang, Dongguan City (CN)

(21) Appl. No.: 17/770,121

(22) PCT Filed: Oct. 31, 2019
(86) PCT No.: PCT/CN2019/114648

§ 371 Date: Apr. 19, 2022

(51) Int. Cl. A01D 34/78; A01D 69/06; A01D 34/71; H02K 5/22; H02K 7/00; H02K 7/116; H02K 11/00; H02K 11/33

(52) U.S. Cl. CPC A01D 34/78; A01D 69/06; A01D 34/71; H02K 5/225; H02K 7/003; H02K 7/116; H02K 11/0094; H02K 11/33; A01D 43/006

(57) ABSTRACT

A motor module (100) for an electrically driven garden tool comprises: a brushless DC motor (102) having a motor drive shaft (104); and a gearbox having an output shaft (108), the gearbox configured to receive the motor drive shaft (104) from the brushless DC motor (102) and drive a rotary element of the electrically driven garden tool with the output shaft (108), wherein the gearbox having a gear reduction ratio of at least 2:1. An electrically driven garden tool comprises: a housing (602) comprising a receptacle for receiving a motor module (100); and a rotary element drivable with an electric motor, the rotary element comprises a receiving element having a keyed interface corresponding to the keyed surface (122) or structure on the output shaft (108) of the motor module (100). A grass compactor (900) comprises: mounting structure to attach the grass compactor (900) to a lawn mower (1000); an inlet (1104) for receiving cut grass from an underside of the lawn mower (1000); a channel (1206) for transporting cut grass from the inlet (1104) to a feed hopper (1400); and a compaction conveyor (1404) configured to receive cut grass from the feed hopper (1400), and to compact and convey cut grass along a length thereof and discharge compacted cut grass from the outlet (1210).

### FIELD

The invention relates to motor modules for electrically driven gardening tools such as electric lawn mowers, electric line trimmers, electric edge trimmers, electric hedge trimmers, electric blowers and the like; and/or electrically driven gardening tools (in particular electric lawn mowers) comprising such motor modules; and/or grass catching devices for lawn mowers to catch and consolidate cut grass.

### BACKGROUND

The present application is directed to powered garden tools, such as lawn mowers, line trimmers, edge trimmers, hedge trimmers, or blowers. There is an ongoing commercial need to improve existing designs and/or develop new designs that exhibit improved functionality and/or reduced production costs.

In view of the above, it is an object of the invention to provide alternative designs and/or improved designs and/or components or arrangements of components for powered garden tools that address one or more of the shortcomings of the prior art.

### SUMMARY OF INVENTION

In one aspect of the invention there is provided a motor module for an electrically driven garden tool comprising:
a brushless DC motor having a motor drive shaft,
a gearbox having an output shaft, the gearbox configured to receive the motor drive shaft from the brushless DC motor and drive a rotary element of the electrically driven garden tool with the output shaft, wherein the gearbox having a gear reduction ratio of at least 2:1.

By gear reduction ratio it is meant that the reduction in rpm of the drive shaft to the output shaft. For avoidance of doubt, a reduction ratio of at least 2:1 is intended to mean that the output shaft has an rpm that is at least ½ the rpm of the drive shaft.

In an embodiment the gear reduction ratio is at least 3:1. Preferably, the gear reduction ratio is at least 4:1. More preferably, the gear reduction ratio is at least 5:1. Most preferably, the gear reduction ratio is at least 6:1.

In an embodiment, the motor drive shaft has a speed of at least 6000 rpm.

In an embodiment, the output drive shaft has a speed of from about 1000 rpm to about 3000 rpm. Preferably, the output drive shaft has a speed of up to about 2500 rpm. More preferably, the output drive shaft has a speed of up to about 3000 rpm.

In an embodiment, the motor drive shaft and the output shaft are coaxially aligned.

Whilst a range of different gearboxes are contemplated, in an embodiment, the gearbox is a planetary gearbox.

In one form of the above embodiment, the planetary gearbox comprises a sun gear driven by the motor drive shaft and two planet gears to drive the rotary element, the sun gear and the two planet gears retained within a stationary ring gear.

In an embodiment, the motor module further comprises a controller to control operation of the brushless DC motor.

In one form of the above embodiment, the controller has a communication interface for electrical connection with the electrically driven garden tool, and preferably with a microchip on the electrically driven garden tool. Preferably, the controller is configured to receive an input from the electrically driven garden tool, such as to identify the type of electrically driven gardening tool and related operating parameters, and/or an input to activate or deactivate the brushless DC motor.

In an embodiment, the motor assembly is a motor module which is removably insertable into the electric lawn mower.

In one form of the above embodiment, the output shaft comprises a keyed surface or structure to connect or interface with a receiving element of the electrically driven garden tool to drive the rotary element of electrically driven garden tool.

In one form of the above embodiment, the motor module further comprises coupling structure to couple the motor module to the electric lawn mower.

In one form of the above embodiment, the motor module further comprises a battery.

In an embodiment, the motor is generally of cylindrical shape having a diameter of from about 20 mm to about 80 mm. Preferably, the removable module has a diameter of from about 30 mm up to about 65 mm.

In an embodiment, the motor is generally of cylindrical shape having a length of from about 60 mm to about 140 mm.

In an embodiment, the motor module is a readily removable and insertable motor module. In such embodiments, the motor module further comprises a housing that contains at least the brushless DC motor and the gearbox (and preferably a battery in embodiments in which a battery is a component of the motor module), and wherein the housing comprises a keyed surface or structure to connect or interface with a receiving element of the electrically driven garden tool to drive the rotary element.

In one form of the above embodiment, the housing comprises a lock element engageable with a cooperative lock element of the electrically driven garden tool, which in a locked state prevents removal of the motor module from the electrically driven garden tool.

In one form of the above embodiment, the motor module further comprises a controller to control operation of the brushless DC motor and the controller is disposed within the housing or on a surface thereof. In forms in which the controller is disposed within the housing, it is preferred that the housing further comprises external electrical contacts electrically connected to the controller, the external electrical contacts arranged to connect with complementary electrical contacts on the electrically driven garden tool.

In a second aspect of the invention, there is provided, an electric lawn mower comprising:
a housing comprising a receptacle for receiving a motor assembly according to the first aspect of the invention and/or embodiments and/or forms thereof; and
a rotary element drivable with an electric motor, the rotary element comprising a receiving element having a keyed interface corresponding to a keyed surface or structure on the output shaft of the motor assembly or motor module.

In an embodiment, the electric lawn mower comprises a lock element engageable with a cooperative lock element of the motor assembly, which in a locked state prevents removal of the motor assembly from the electric lawn mower.

In a third aspect of the invention, there is provided a removably insertable motor module for individually powering a plurality of electrically driven garden tools comprising:
a brushless DC motor having a motor drive shaft;
a gearbox having an output shaft, the gearbox configured to receive the motor drive shaft from the brushless DC motor and drive a rotary element of the electrically driven garden tool with the output shaft; and
mounting structure for engaging with reciprocal structure on each of a plurality of electrically driven garden tools to independently and removably mount the motor module to each of the plurality of electrically driven garden tools.

In an embodiment, the gearbox has a gear reduction ratio of at least 2:1. Preferably, the gear reduction ratio is at least 5:1.

In an embodiment, the motor drive shaft has a speed of at least 6000 rpm, and the output drive shaft has a speed of from about 1000 rpm to about 3000 rpm.

In an embodiment, the motor drive shaft and the output shaft are coaxially aligned.

In an embodiment, the gearbox is a planetary gearbox.

In one form of the above embodiment, the planetary gearbox comprises a sun gear driven by the motor drive shaft and two planet gears to drive the rotary element, the sun gear and the two planet gears retained within a stationary ring gear.

In an embodiment, the output shaft comprises a keyed surface or structure to connect or interface with a receiving element of the electrically driven garden tool to drive the rotary element of electrically driven garden tool.

In an embodiment, the motor is generally of cylindrical shape having a diameter of from about 20 mm to about 80 mm.

In an embodiment, the motor is generally of cylindrical shape having a length of from about 60 mm to about 140 mm.

In an embodiment, the motor module further comprises a controller to control operation of the brushless DC motor.

In one form of the above embodiment, the controller is configured to receive an input from the electrically driven garden tool, to identify the type of electrically driven gardening tool and related operating parameters, and/or to activate and deactivate the brushless DC motor.

In an embodiment, the motor module further comprises coupling structure to couple the motor module to the electrically driven garden tool.

In an embodiment, the motor module further comprises a battery.

In an embodiment, the motor module further comprises a housing that contains at least the brushless DC motor and the gearbox, and wherein the housing comprises a keyed surface or structure to connect or interface with a receiving element of the electrically driven gardening tool to drive the rotary element.

In an embodiment, the housing comprises a lock element engageable with a cooperative lock element of the electrically driven garden tool, which in a locked state prevents removal of the motor module from the electrically driven garden tool.

In an embodiment, the motor module further comprises a controller to control operation of the brushless DC motor and the controller is disposed within the housing or on a surface thereof; and the housing further comprises external electrical contacts electrically connected to the controller, the external electrical contacts arranged to connect with complementary electrical contacts on the electrically driven garden tool.

In a fourth aspect of the invention, there is provided an electrically driven garden tool comprising:
a housing comprising a receptacle for receiving a motor module according to the first aspect of the invention, or embodiments or forms thereof; and
a rotary element drivable with an electric motor, the rotary element comprising a receiving element having a keyed interface corresponding to the keyed surface or structure on the output shaft of the motor module.

A range of different electrically driven garden tools are contemplated, particularly those having rotating motor driven components. A non-limiting example of such tools includes: tools with rotational output such as lawnmowers, line trimmers, edge trimmers, and the like; tools that make use of rotational motor driven components such as leaf blowers; or tools that have a linear or reciprocating motion output which is derived from a rotational motor driven component.

In an embodiment, the electrically driven garden tool comprises a lock element engageable with a cooperative lock element of the motor module, which in a locked state prevents removal of the motor module from the electrically driven garden tool.

In a fifth aspect of the invention, there is provided a grass compactor comprising:
mounting structure to attach the grass compactor to a lawn mower;
an inlet for receiving cut grass from an underside of the lawn mower;
a feed hopper; and
a compaction conveyor configured to receive cut grass from the feed hopper, and to compact and convey cut grass along a length thereof and discharge compacted cut grass from the outlet thereof.

In an embodiment, the grass compactor further comprises a motor to drive the compaction conveyor.

In one form of the above embodiment, the mounting structure includes an electrical connector for electrical connection with a battery of the lawn mower to power the motor.

In an embodiment, the compaction conveyor is a screw conveyor that has a narrowing tapered diameter along its length that narrows toward the outlet.

In an embodiment, the feed hopper is disposed above the compaction conveyor to gravity feed the cut grass to the compaction conveyor.

In an embodiment, the grass compactor further comprises a channel for transporting cut grass from the inlet to the feed hopper.

In one form of the above embodiment, the channel is upwardly inclined from the inlet to the feed hopper.

In an embodiment, the channel comprises an air vent in the region of, near, or adjacent the feed hopper.

In an embodiment, the channel is upwardly inclined from the inlet to the feed hopper.

In a sixth aspect of the invention there is provided a lawn mower comprising the grass compactor of the fifth aspect and/or embodiments and/or forms thereof.

In an embodiment, the lawn mower is an electric lawn mower, and the electric lawn mower comprises a motor assembly according to the first aspect of the invention and/or embodiments and/or forms thereof, or the motor module of the third aspect of the invention and/or embodiments and/or forms thereof.

In a seventh aspect of the invention n electric push lawn mower comprising:
a lawn mower body housing a rotatable blade and an electric motor operatively connected to the rotatable blade to rotate the rotatable blade; and
a handle portion extending from the lawn mower body for a user to push and/or pull the lawn mower during operation;
wherein the lawn mower body further comprises a transport chute arranged above the rotatable blade and configured to receive cut grass from an underside of the lawn mower body and to transport the cut grass to a grass catcher.

In an embodiment, the transport chute is integrally formed with the lawn mower body.

In an embodiment, the transport chute comprises an inlet that opens into the underside of the lawn mower body and an outlet for discharging cut grass into the grass catcher.

In an embodiment, the transport chute is substantially cylindrical in internal cross-section and has a longitudinal axis that is substantially parallel to an axis of rotation of the rotatable blade.

In an embodiment, the transport chute tapers along the longitudinal axis narrowing in a direction away from the rotatable blade.

In an embodiment, the transport chute has an outlet portion, and the outlet portion extends in a direction that is substantially perpendicular to the longitudinal axis.

In one form of the above embodiment, the outlet portion includes a feed hopper, the feed hopper configured to receive the cut grass and to feed the cut grass to a grass compactor. Preferably, the grass compactor is a grass compactor according to the fifth aspect and/or embodiments and/or forms thereof.

In an embodiment, the motor is a brushless DC motor.

In an embodiment, the motor is generally of cylindrical shape having a diameter of from about 20 mm to about 80 mm.

In an embodiment, the motor is generally of cylindrical shape having a length of from about 60 mm to about 140 mm.

In an embodiment, the motor is a motor assembly according to the first aspect and/or embodiments and/or forms thereof. or a motor module according to the third aspect and/or embodiments and/or forms thereof.

In an embodiment, the transport chute is vertically oriented relative to the electric push lawn mower during use.

In one or more forms of the aspects or embodiments described above, the lawn mower is a push lawn mower.

In one or more forms of the aspects or embodiments described above, the lawn mower is not a ride-on lawn mower.

### BRIEF DESCRIPTION OF DRAWINGS

FIG. 1 is a perspective line drawing of a motor module according to one embodiment of the invention.

FIG. 2 is an exploded view of the motor module of FIG. 1.

FIG. 3 is a perspective top view line drawing of a lawn mower body including a motor module according to one embodiment of the invention.

FIG. 4 is a perspective under view line drawing of the lawn mower of FIG. 3.

FIG. 5 is a perspective line drawing of an electric lawn mower in accordance with an embodiment of the invention.

FIG. 6 is a perspective line drawing of an electric lawn mower in accordance with an embodiment of the invention.

FIG. 7 is a perspective line drawing showing the internal components of the electric lawn mower of FIG. 6.

FIG. 8 is a perspective line drawing showing the underside of the lawn mower of FIG. 6.

FIG. 9 is a perspective line drawing showing the rear view of the lawn mower of FIG. 6 with a grass compactor.

FIG. 10 is a perspective line drawing of an electric lawn mower in accordance with an embodiment of the invention.

FIG. 11 is a cross-sectional view of the lawn mower of FIG. 10.

FIG. 12 is a front view of an embodiment of a grass compactor, such as to be installed in a horizontal configuration on the rear of a lawn mower.

FIG. 13 is a rear view of the grass compactor of FIG. 12.

FIG. 14 is a perspective view of the grass compactor of FIG. 12.

FIG. 15 is a close-up cross-sectional view of the transport chute of the lawn mower of FIG. 10 showing a grass compactor.

### DESCRIPTION OF EMBODIMENTS

In one form the invention relates to a motor assembly for an electrically driven garden tool. Generally, the motor assembly comprises at least a brushless DC motor and a gearbox having a gear reduction ratio of at least 5:1.

Conventional electrically driven garden tools, and in particular electric lawn mowers, typically make use of a large brushed or brushless DC motors in order to achieve a high torque output to meet their intended purpose. In contrast, the inventors have found that a motor assembly including a small brushless DC motor provides a number of advantages over conventional brushed DC motors.

Small brushless DC motor tends to have high speed output (for example greater than 6000 rpm) and low torque output for a given a power. Given this, small brushless DC motors are generally considered to be unsuitable for use in electric gardening tools, and particularly those tools thought to have a high torque requirement (e.g. electric lawn mowers).

In conventional gardening tools, such as with electric lawn mowers, this high rpm is considered beneficial for achieving the desired grass cutting effect. However, the inventors have now found that reducing the rpm by a factor of at least 5 (e.g. an output rpm of 1000-3000 rpm) still results in a satisfactory cutting effect whilst providing additional benefits.

The use of a lower rpm also provides further advantages. For a given torque output, decreasing the rpm reduces the power consumption requirements of the tool, which in turn extends battery life.

The motor assembly can be of a modular configuration, such that the module can be dissembled from the lawn mower and applied to other types of power tools, such as a blower. This modular configuration is enabled partly by the compact design. Different power tools usually require separate motor system for each different electrically driven garden tool since they have different operating parameters. This can be addressed, in part, by providing a power module that includes a control circuit which is able to interface with the electrically driven garden tool to determine required operating parameters. Given this, in one or more forms, the motor assembly and/or motor module provides for simplified design and mass production of gardening tools since it can be used in a range of different products.

A non-limiting example of electric gardening tools includes: an electric lawn mower, an electric line trimmer, an electric edge trimmer, an electric hedge trimmer, or an electric blower.

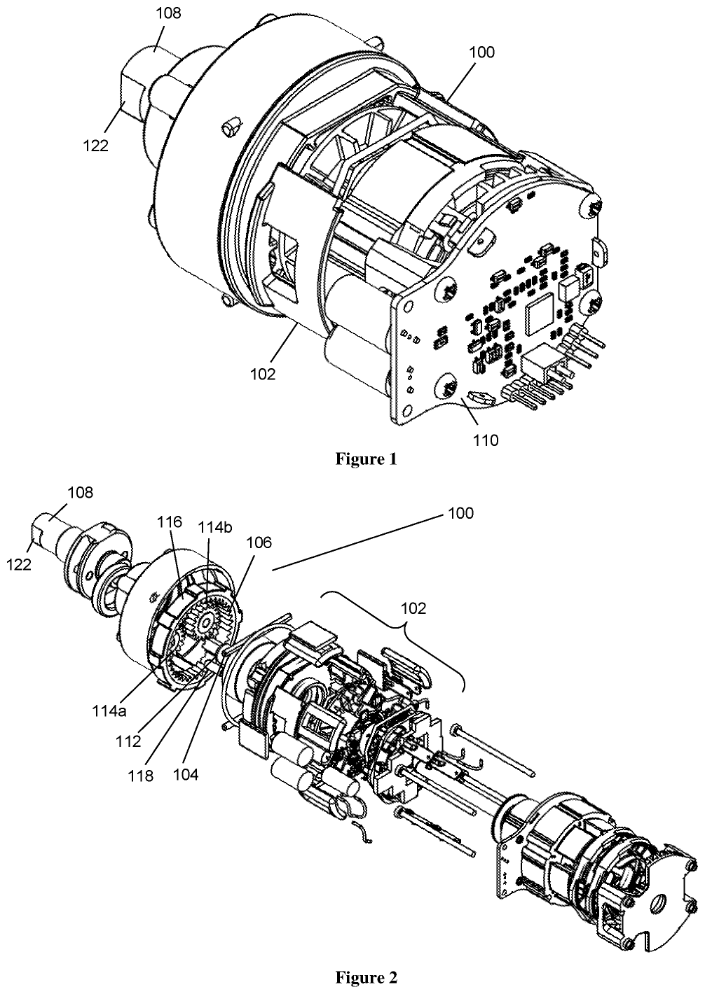

FIG. 1 provides an illustration of one embodiment of a motor module 100. FIG. 2 provides an exploded view of the motor module 100 of FIG. 1.

The motor module 100 comprises: a brushless DC motor 102 having a drive shaft 104; a gear train 106 for receiving a gear end of the drive shaft 104 and driving an output shaft 108 at a reduction ratio of the gear train. The motor module also comprises a control circuit 110 to control operation of the brushless DC motor 102 and/or to communicate with electronics of an electrically driven garden tool powered by the motor module 100.

It will be appreciated that different gear train systems may be used. However, in the embodiment of FIGS. 1 and 2, the gear train 106 is in the form of a planetary gear train 106. Planetary gear trains are particularly advantageous in the present motor module since they are able to provide a large gear reduction ratio with compact design. The planetary gear train 106 receives the gear end of the drive shaft 104 in the form of a central sun gear 112 about which orbit two planet gears 114a and 114 constrained within an outer fixed ring gear 116.

The planet gears 114a and 114b each comprise a pinion 118 extending therefrom for connection with a carrier 120 which, upon rotation of the planet gears 114a and 114b, causes rotation of output shaft 108 at the gear reduction ratio of the gear train relative to drive shaft 104.

By gear reduction ratio it is meant that the reduction in rpm of the drive shaft to the output shaft. For avoidance of doubt, a reduction ratio of at least 2:1 is intended to mean that the output shaft has an rpm that is at least ½ the rpm of the drive shaft. In one embodiment, the gear reduction ratio is at least 3:1. In another embodiment, the gear reduction ratio is at least 4:1. In a further embodiment, the gear reduction ratio is at least 5:1. In still a further embodiment, the gear reduction ratio is at least 6:1. Furthermore, in one embodiment, the gear reduction ratio is up to 12:1. In another embodiment, the gear reduction ratio is up to 10:1. In a further embodiment, the gear reduction ratio is up 8:1.

The output shaft 108 comprises a keyed surface 122 to couple the output shaft 108 with a rotary element on the electrically driven garden tool to drive or otherwise actuate the electrically driven garden tool.

The control circuit 110 controls operation of the brushless DC motor 102 and comprises electrical connections which contact electronics of the electrically driven garden tool. This allows control of the brushless DC motor 102 such as from a control panel of the electrically driven garden tool (e.g. an on/off switch or a settings dial which may be located on a handle of the electrically driven garden tool). The control circuit 110 may also read information from memory stored on the electrically driven garden tool such as to identify the type of electrically driven garden tool and corresponding operating parameters.

In the illustrated embodiment, the motor module 100 does not include a battery. Instead, power is supplied to the motor module 100 via an electrical connection between a battery in the electrically driven garden tool and the control circuit 110 of the motor module 100. However, in alternative forms, the motor module 100 further comprises a battery, which may for example be mounted on top of the control circuit 110.

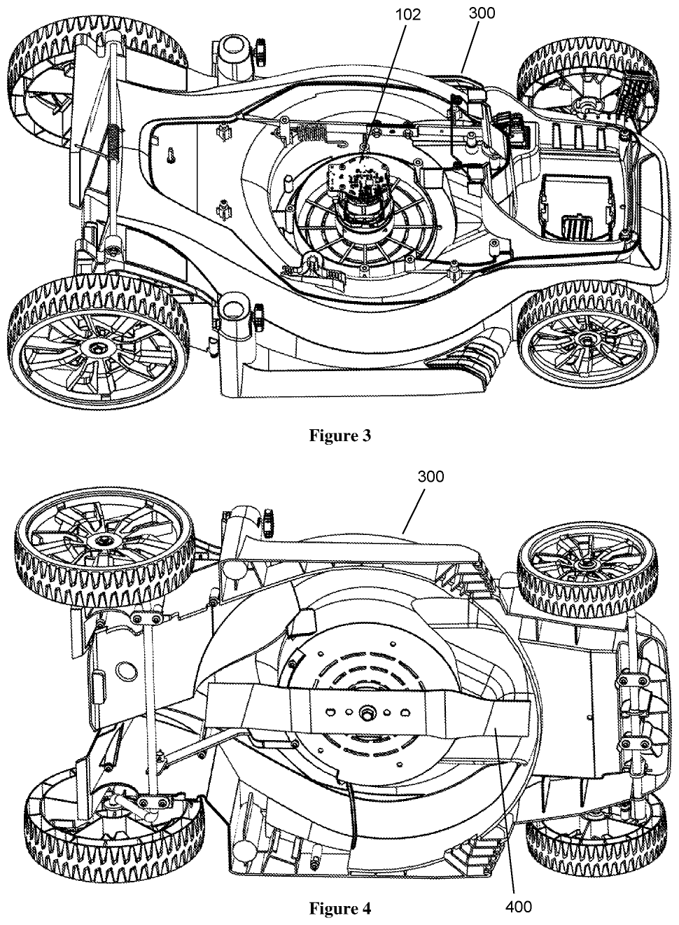

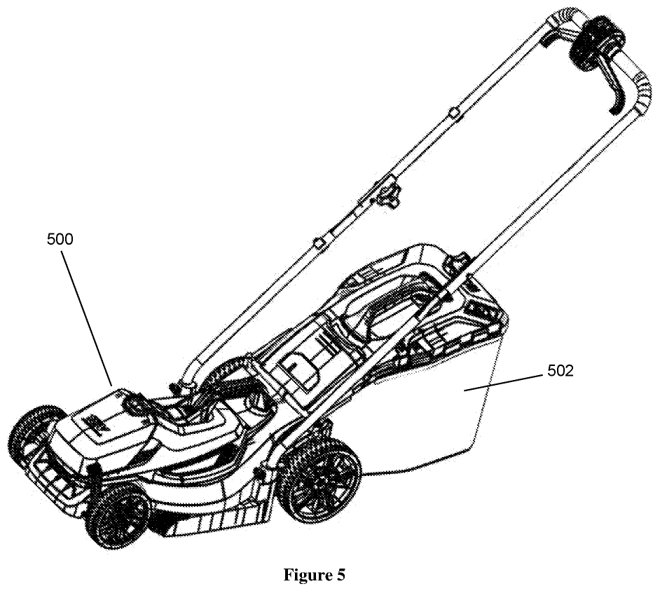

FIG. 3 and FIG. 4 illustrate the placement of the motor module 102 in the body of an electric lawn mower 300. FIG. 3 is a top down view showing the placement of the motor module 102 in a central cavity of the electric lawn mower for driving a mower blade 400 (see FIG. 4). FIG. 4 is a view of the underside of the electric lawn mower 300 which shows the mower blade 400 coupled to the output shaft 108 of the motor module 100.

In the embodiment illustrated in FIGS. 3 and 4, the motor module 100 is fixed within the body of the electric lawn mower 300 via conventional means e.g. via screws or the like. The motor module 100 may be removed from the electric lawn mower 300 such as by removing the fixtures and used in other electrically driven gardening tools.

In alternative forms of the invention, the motor module is readily removable and insertable into a range of different electrically driven garden tools. In such forms, the motor module further comprises an outer housing part that has a lock element engageable with a cooperative lock element of the electrically driven garden tool. By way of example, the outer housing can include a threaded surface for threaded engagement with a cooperative receiving surface in the electrically driven garden tool; the outer housing can include either a cam or groove for forming a camlock to the receiving surface; the outer housing can include a latch structure or latch receiving structure to mechanically fasten the motor module to the receiving surface.

The motor module 100 is of compact design. The motor module is generally of cylindrical shape having a diameter (such as along a direction transverse to the axial direction of the cylindrically shaped motor) of from about 20 mm to about 80 mm. Preferably, the diameter is from about 25 mm. More preferably, the diameter is from about 30 mm. Most preferably, the diameter is from about 35 mm. Alternatively or additionally, the diameter is up to about 75 mm. Preferably, the diameter is up to about 70 mm. More preferably, the diameter is up to about 65 mm. Most preferably, the diameter is up to about 60 mm.

The motor has a length (such as along an axial direction of the cylindrically shaped motor) of from about 60 to 140 mm. Preferably, the length is from about 65 mm. More preferably, the length is from about 70 mm. Most preferably, the length is from about 75 mm. Alternatively or additionally, the length is up to about 130 mm. Preferably, the length is up to about 125 mm. More preferably, the length is up to about 120 mm. Most preferably, the length is up to about 115 mm.

In another form, the invention relates to an electric lawn mower that comprises a motor module comprising a brushless DC motor having a motor drive shaft, and a gearbox configured to receive the motor drive shaft from the brushless DC motor and drive a rotary element of the electrically driven garden tool, the gearbox having a gear reduction ratio of at least 5:1. The motor module can further include the features described above.

The inventors have found that the use of this power module in an electric lawn mower is particularly advantageous since it allows for an electric lawn mower of more compact design since the lawn mower no longer needs internal space to accommodate a much larger standard brushed DC motor.

FIG. 5 provides an illustration of a compact electric lawn mower 500 with grass catcher 502 attached thereto, but which includes the motor module 100 of the present invention (refer to FIGS. 3 and 4 which illustrate the internal components of the electric lawn mower of FIG. 5). As can be seen, the motor module 100 occupies only a small amount of internal space within the lawn mower 500. This provides a number of potential benefits, including reduced weight and energy consumption of the lawn mower 500 and provision of space to modify of the existing design to include further elements. The small motor module 100 advantageously allows for the compact design of mower 500.

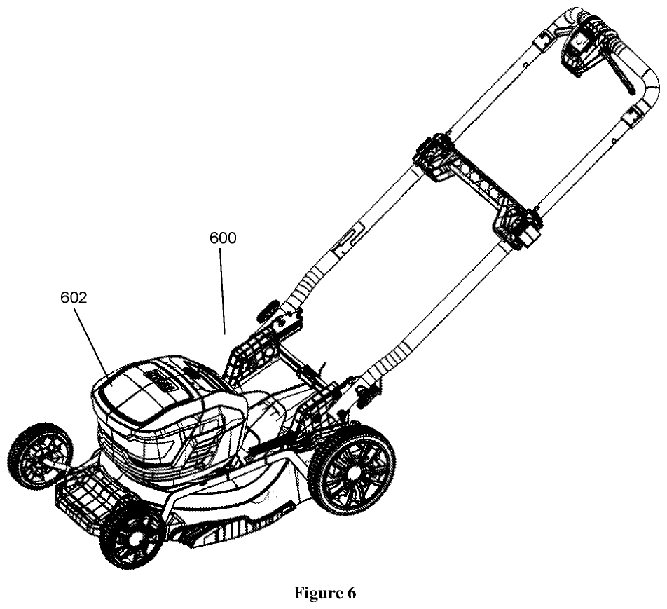

FIG. 6 shows an external view of compact mower 600 according to another embodiment with motor housing 602.

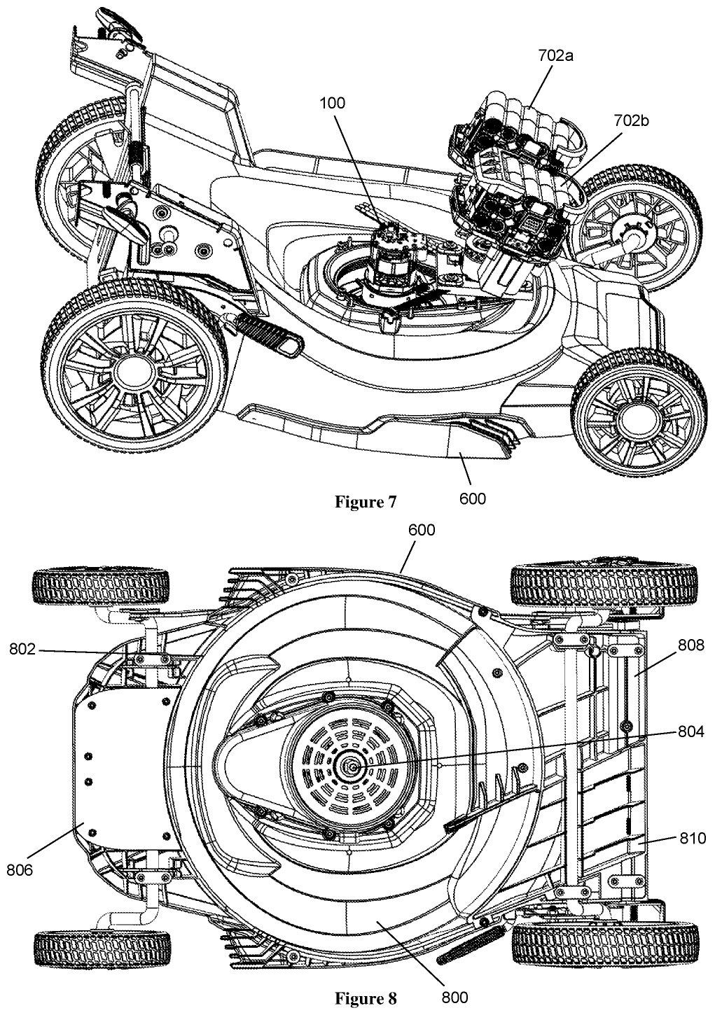

FIG. 7 shows a view of compact mower 600 with the motor housing 602 removed to show the internal components contained within motor housing 602, and in particular motor module 100 and battery packs 702a and 702b. In this embodiment, battery packs 702a and 702b are not part of motor module 100 and are instead fixed to an upper surface of the compact mower 600. Battery packs 702a and 702b are electrically connectable to motor module 100 when motor module 100 is installed in compact mower 600. Notably, motor module 100 occupies little internal space within motor housing 602.

FIG. 8 is a view of the underside 800 of compact mower 600 showing circular blade housing 802, cutting blade mount 804 (noting that no blade is depicted in FIG. 8), front wheel mount portion 806, and rear wheel mount portion 808 which comprises a chute 810 for discharging cut grass from the underside 800 of compact mower 600—such as into a grass catcher 502 as generally illustrated in relation to the embodiment depicted in FIG. 5.

Since the motor module 100 occupies little internal space within motor housing 602, motor housing 602 is smaller than a typical motor housing on a standard lawn mower. This allows a more compact mower design for a given circular blade housing size. In this embodiment, the distance between a rearward most portion of the circular blade housing and the outlet of chute 810 is less than 60% of the radius of chute 810. Preferably, the distance between the rearward most portion of the circular blade housing and the outlet of chute 810 is less than 55% the radius of chute 810. More preferably, the distance between the rearward most portion of the circular blade housing and the outlet of chute 810 is less than 50% the radius of chute 810. Even more preferably, the distance between the rearward most portion of the circular blade housing and the outlet of chute 810 is less than 45% the radius of chute 810. Most preferably, the distance between the rearward most portion of the circular blade housing and the outlet of chute 810 is less than 40% the radius of chute 810. This likewise applies to the embodiment depicted in FIG. 5.

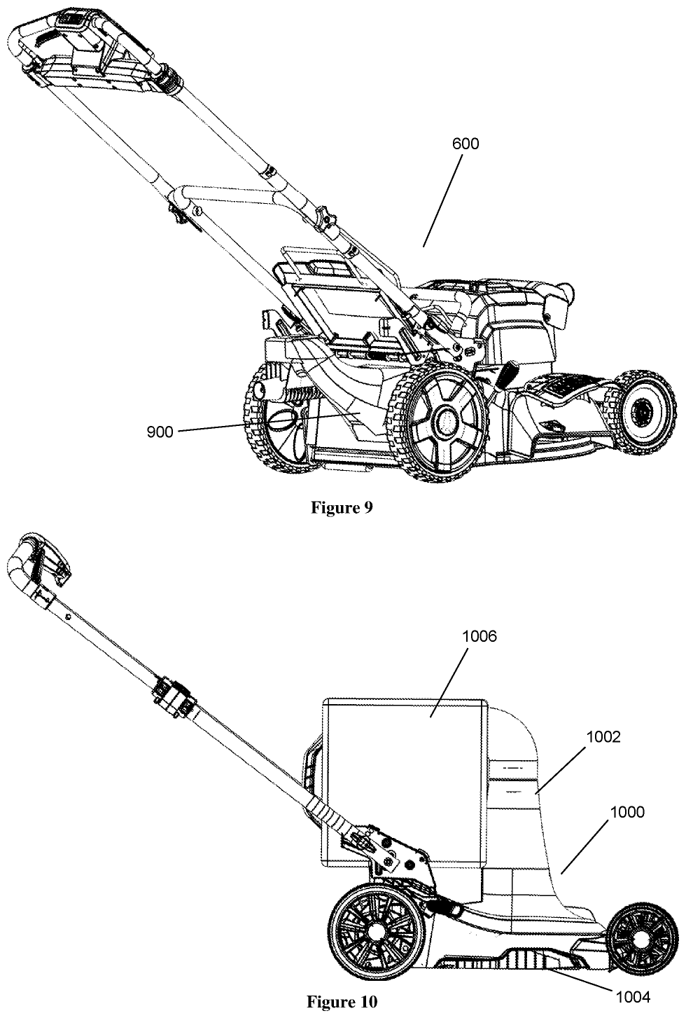

FIG. 9 is a perspective view line drawing of compact mower 600 with a grass compactor 900 horizontally mounted to a rear surface thereof. Grass compactor 900 will be described in more detail below. However, in brief, grass compactor 900 is mounted to a rear portion of compact mower 600 to receive cut grass from the underside of compact mower 600 whereby the grass compactor compacts the cut grass prior to discharging the compacted cut grass into a grass catcher (not shown).

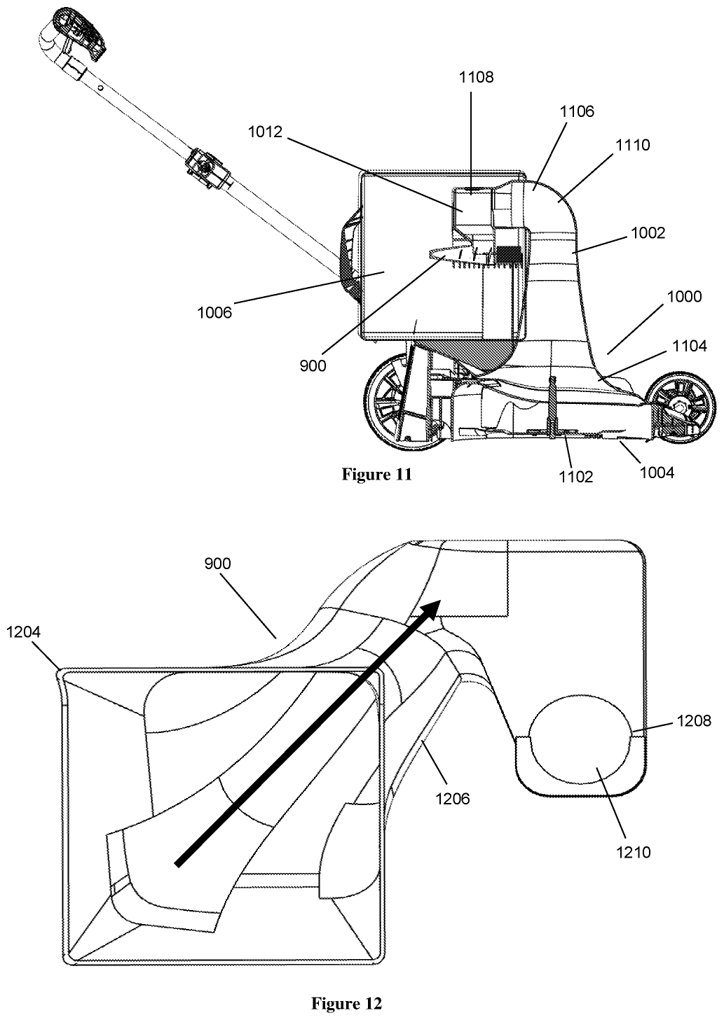

Another benefit brought by the compact design is the possibility to provide a vertically arranged grass catcher structure above the blade and the power assembly. The grass cut off by the blade can be blown into the vertically arranged grass catcher structure through space that would otherwise be occupied by the relatively large motor. The vertically arranged catcher structure achieves higher energy efficiency as compared with a horizontally mounted grass catcher structure arranged at the rear of mower, because there is no energy loss in re-direction of the cut-off grass. FIG. 10 and FIG. 11 illustrate an alternative embodiment in which lawn mower 1000 comprises a vertically catcher structure that comprises a vertically oriented chute 1002 arranged above rotatable cutting blade 1102 for receiving cut grass from an underside 1004 of lawn mower 1000 and transporting that cut grass to grass catcher 1006 located above or on top of upperside 1008 of lawn mower 1000.

The vertically oriented chute 1002 has an internal structure that is generally cylindrical in shape, but which has an outwardly flared inlet 1104 for receiving cut grass from the underside 1004 of mower 1000 and which narrowingly tapers from the inlet 1104 to an outlet portion 1106 of vertically oriented chute 1002. This shape is beneficial for the transport of cut grass from the inlet 1104 to outlet portion 1106. Outlet portion 1106 comprises discharge structure 1108 comprising an elbow structure 1110 (which in this case extends in a direction substantially perpendicular to the longitudinal axis of vertically oriented chute 1002) for redirecting cut grass into grass catcher 1006. As will be described in more detail below, outlet portion 1106 also comprises hopper 1012 for feeding cut grass into grass compactor 900 prior to discharge into grass catcher 1006.

Generally, the height of the vertically oriented chute 1002 is from about 20 cm up to about 120 cm. Preferably, the height of the vertically oriented chute 1002 is from about 25 cm. More preferably, the height of the vertically oriented chute 1002 is from about 30 cm. Most preferably, the height of the vertically oriented chute 1002 is from about 32 cm. Additionally, or alternatively, it is preferred that the height of the vertically oriented chute 1002 is up to about 100 cm. More preferably, the height of the vertically oriented chute 1002 is up to about 80 cm. Even more preferably, the height of the vertically oriented chute 1002 is up to about 70 cm. Still more preferably, the height of the vertically oriented chute 1002 is up to about 60 cm. Most preferably, the height of the vertically oriented chute 1002 is up to about 62 cm.

Generally, the inlet 1104 of the vertically oriented chute 1002 has an inlet diameter of about 15 cm up to about 30 cm. Preferably, the inlet diameter is from about 17 cm. More preferably, the inlet diameter is from about 19 cm. Most preferably, the inlet diameter is from about 21 cm. Additionally or alternatively, it is preferred that the inlet diameter is up to about 27 cm. More preferably, the inlet diameter is up to about 24 cm. Most preferably, the inlet diameter is from about 22 cm. In one example, the inlet diameter is 21.3 cm.

Generally, the outlet portion 1106 of the vertically oriented chute 1002 has an outlet diameter of about 2 cm up to about 5 cm. Preferably, the outlet diameter is from about 2.5 cm. More preferably, the outlet diameter is from about 3 cm. Most preferably, the outlet diameter is from about 3.2 cm. Additionally or alternatively, it is preferred that the outlet diameter is up to about 4.5 cm. More preferably, the outlet diameter is up to about 4 cm. Most preferably, the outlet diameter is from about 3.6 cm. In one example, the outlet diameter is 3.4 cm.

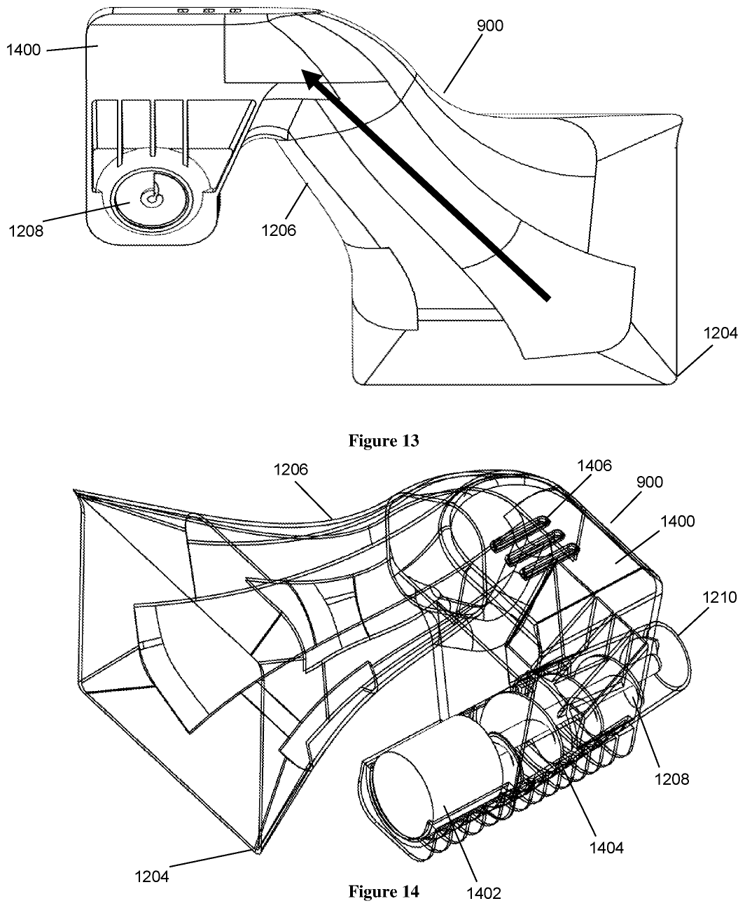

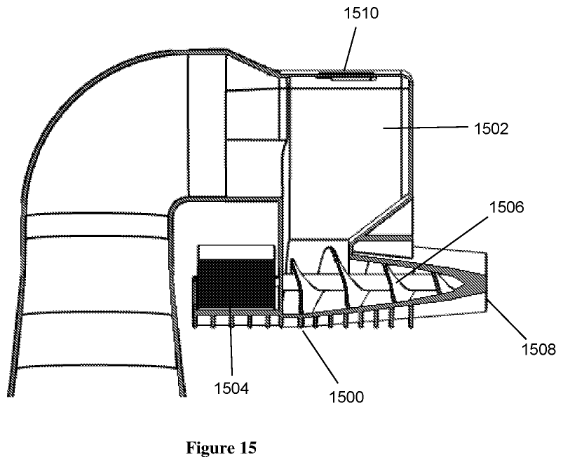

In still another form, the invention relates to a grass compactor for use with a lawn mower, such as (but not limited to) an electric lawn mower as generally described above. FIG. 12, FIGS. 13, and 14 illustrate a first form of grass compactor 900 (refer also to FIG. 9 showing the first form of grass compactor 900 mounted to a rear side of compact mower 600, and to FIG. 11 showing a second form of a grass compactor mounted to an upper side of mower 1000).

With reference to FIGS. 12, 13, and 14, the first form of grass compactor 900 comprises mounting structure 1204 to attaching the grass compactor 900 to the lawn mower; an inlet 1204 to receive cut grass from an underside of the lawn mower; a flow channel 1206 for transporting cut grass from the inlet to a collection area; a compaction conveyor 1208 configured to receive the cut grass and to compact and convey the cut grass to a discharge outlet 1210 where the compacted cut grass is discharged from the grass compactor 900, such as into a grass collector (see for example item 502 of FIG. 5). In the first form, the grass compactor 900 is screw-mounted to the lawn mower. However, the skilled person will appreciate that grass compactor 900 may be attached via other mounting structures, such as with clips, slide track channels, bolts, and the like.

FIG. 14 shows the compaction conveyor 1208 in more detail. The compaction conveyor 1208 comprises: a feed hopper 1400 to receive cut grass from a flow of air in which the cut grass is entrained via flow channel 1206; a motor 1402 to drive a screw conveyor 1404 that has a tapering diameter along its length, narrowing toward the discharge outlet 1210. Also illustrated is vent 1406 to vent air adjacent the feed hopper 1400 to maintain an air flow path between at least the inlet 1204 and the terminus of the flow path at the feed hopper 1400.

Returning to FIG. 12 and FIG. 13, these figures provide an illustration of airflow 1212 with cut grass entrained therein during operation of a mower. In more detail, during operation, the blade of a mower cuts grass which is then entrained in the airflow generated by the rotational movement of the mower blade.

In this form, the inlet 1204 to the grass compactor 900 is mounted to the rear of a mower (see for example the embodiments illustrated in FIG. 5 and FIG. 9) and is in the form of a window that has a planar orientation tangential to the rotation of the mower blade. In this way, the opening is positioned to receive the airflow, with cut grass entrained therein, in a direction that is normal to the rotation of the mower blade. The airflow 1212 (and entrained cut grass) enters the grass compactor 900 through inlet 1204 where it progresses along an upwardly inclined flow channel 1406 to an end of the flow channel 1406 which includes feed hopper 1400 to receive the cut grass and vent 1406 to allow air to egress from the system and thus maintain the airflow path. The flow channel 1406 is inclined so as to reduce the turbulence of the airflow to aid deposition of grass in the hopper.

In a second form, the grass compactor 1500 comprises a feed hopper 1502 to receive cut grass from a flow of air in which the cut grass is entrained (in this embodiment via a vertically oriented chute e.g. see 1002 item of FIGS. 10 and 11) and to feed cut grass to grass compactor 1500; a motor 1504 to drive a screw conveyor 1506 that has a tapering diameter along its length, narrowing toward the discharge outlet 1508. Also illustrated is vent 1510 to vent air adjacent the feed hopper 1502 to maintain an air flow path within grass compactor 1500. The feed hopper 1502 is arranged above an inlet to screw conveyor 1506 such that cut grass is gravity fed from feed hopper 1502 into screw conveyor 1506.

1. A motor assembly for an electric lawn mower comprising:
a brushless DC motor having a motor drive shaft; and
a gearbox having an output shaft, the gearbox configured to receive the motor drive shaft from the brushless DC motor and drive a rotary element of the electrically driven garden tool with the output shaft, wherein the gearbox having a gear reduction ratio of at least 2:1.

2. The motor assembly of claim 1, wherein the gear reduction ratio is at least 5:1.

3. The motor assembly of claim 1, wherein the motor drive shaft has a speed of at least 6000 rpm, and the output drive shaft has a speed of from about 1000 rpm to about 3000 rpm.

4. The motor assembly of claim 1, wherein the motor drive shaft and the output shaft are coaxially aligned.

5. The motor assembly of claim 1, wherein the gearbox is a planetary gearbox.

6. The motor assembly of claim 5, wherein the planetary gearbox comprises a sun gear driven by the motor drive shaft and two planet gears to drive the rotary element, the sun gear and the two planet gears retained within a stationary ring gear.

7. The motor assembly of claim 1, wherein the motor assembly further comprises a controller to control operation of the brushless DC motor.

8. The motor assembly of claim 1, wherein the motor assembly is a motor module which is removably insertable into the electric lawn mower.

9. The motor assembly of claim 8, wherein the output shaft comprises a keyed surface or structure to connect or interface with a receiving element of the electric lawn mower to drive the rotary element of the electric lawn mower.

10. The motor assembly of claim 8, wherein the motor module further comprises a controller to control operation of the brushless DC motor.

11. The motor assembly of claim 10, wherein the controller is configured to receive an input from the electrically driven garden tool, to identify the type of electric lawn mower and related operating parameters, and/or to activate and deactivate the brushless DC motor.

12. The motor assembly of claim 8, wherein the motor module further comprises coupling structure to couple the motor module to the electric lawn mower.

13. The motor assembly of claim 8, wherein the motor module further comprises a battery.

14. The motor assembly of claim 8, wherein the motor module further comprises a housing that contains at least the brushless DC motor and the gearbox, and wherein the housing comprises a keyed surface or structure to connect or interface with a receiving element of the electric lawn mower to drive the rotary element.

15. The motor assembly of claim 14, wherein the housing comprises a lock element engageable with a cooperative lock element of the electric lawn mower, which in a locked state prevents removal of the motor module from the electric lawn mower.

16. The motor assembly of claim 14, wherein the motor module further comprises a controller to control operation of the brushless DC motor and the controller is disposed within the housing or on a surface thereof; and the housing further comprises external electrical contacts electrically connected to the controller, the external electrical contacts arranged to connect with complementary electrical contacts on the electric lawn mower.

17. The motor assembly of claim 1, wherein the motor is generally of cylindrical shape having a diameter of from about 20 mm to about 80 mm.

18. The motor assembly of claim 1, wherein the motor is generally of cylindrical shape having a length of from about 60 mm to about 140 mm.

19. An electric lawn mower comprising:
a housing comprising a receptacle for receiving a motor assembly according to claim 1; and
a rotary element drivable with an electric motor, the rotary element comprising a receiving element having a keyed interface corresponding to a keyed surface or structure on the output shaft of the motor assembly or motor module.

20. The electric lawn mower of claim 19, wherein the electric lawn mower comprises a lock element engageable with a cooperative lock element of the motor assembly, which in a locked state prevents removal of the motor assembly from the electric lawn mower.

21. A removably insertable motor module for individually powering a plurality of electrically driven garden tools comprising:
a brushless DC motor having a motor drive shaft; and
a gearbox having an output shaft, the gearbox configured to receive the motor drive shaft from the brushless DC motor and drive a rotary element of the electrically driven garden tool with the output shaft; and
mounting structure for engaging with reciprocal structure on each of a plurality of electrically driven garden tools to independently and removably mount the motor module to each of the plurality of electrically driven garden tools.

22. The removably insertable motor module of claim 21, wherein the gearbox has a gear reduction ratio of at least 2:1.

23. The removably insertable motor module of claim 22, wherein the gear reduction ratio is at least 5:1.

24. The removably insertable motor module of claim 21, wherein the motor drive shaft has a speed of at least 6000 rpm, and the output drive shaft has a speed of from about 1000 rpm to about 3000 rpm.

25. The removably insertable motor module of claim 21, wherein the motor drive shaft and the output shaft are coaxially aligned.

26. The removably insertable motor module of claim 21, wherein the gearbox is a planetary gearbox.

27. The removably insertable motor module of claim 26, wherein the planetary gearbox comprises a sun gear driven by the motor drive shaft and two planet gears to drive the rotary element, the sun gear and the two planet gears retained within a stationary ring gear.

28. The removably insertable motor module of claim 21, wherein the output shaft comprises a keyed surface or structure to connect or interface with a receiving element of the electrically driven garden tool to drive the rotary element of electrically driven garden tool.

29. The removably insertable motor module of claim 21, wherein the motor is generally of cylindrical shape having a diameter of from about 20 mm to about 80 mm.

30. The removably insertable motor module of claim 21, wherein the motor is generally of cylindrical shape having a length of from about 60 mm to about 140 mm.

31. The removably insertable motor module of claim 21, wherein the motor module further comprises a controller to control operation of the brushless DC motor.

32. The removably insertable motor module of claim 31, wherein the controller is configured to receive an input from the electrically driven garden tool, to identify the type of electrically driven gardening tool and related operating parameters, and/or to activate and deactivate the brushless DC motor.

33. The removably insertable motor module of claim 21, wherein the motor module further comprises coupling structure to couple the motor module to the electrically driven garden tool.

34. The removably insertable motor module of claim 21, wherein the motor module further comprises a battery.

35. The removably insertable motor module of claim 21, wherein the motor module further comprises a housing that contains at least the brushless DC motor and the gearbox, and wherein the housing comprises a keyed surface or structure to connect or interface with a receiving element of the electrically driven gardening tool to drive the rotary element.

36. The removably insertable motor module of claim 21, wherein the housing comprises a lock element engageable with a cooperative lock element of the electrically driven garden tool, which in a locked state prevents removal of the motor module from the electrically driven garden tool.

37. The removably insertable motor module of claim 21, wherein the motor module further comprises a controller to control operation of the brushless DC motor and the controller is disposed within the housing or on a surface thereof; and the housing further comprises external electrical contacts electrically connected to the controller, the external electrical contacts arranged to connect with complementary electrical contacts on the electrically driven garden tool.

38. An electrically driven garden tool comprising:
a housing comprising a receptacle for receiving a motor module according to claim 21; and
a rotary element drivable with an electric motor, the rotary element comprising a receiving element having a keyed interface corresponding to the keyed surface or structure on the output shaft of the motor module.

39. The electrically driven garden tool of claim 38, wherein the electrically driven gardening tool is selected from the group consisting of lawnmowers, line trimmers, edge trimmers, hedge trimmers, or leaf blowers.

40. The electrically driven garden tool of claim 38, wherein the electrically driven garden tool comprises a lock element engageable with a cooperative lock element of the motor module, which in a locked state prevents removal of the motor module from the electrically driven garden tool.

41. A grass compactor for a lawn mower comprising:
mounting structure to attach the grass compactor to the lawn mower;
an inlet for receiving cut grass from an underside of the lawn mower;
a feed hopper; and
a compaction conveyor configured to receive cut grass from the feed hopper, and to compact and convey cut grass along a length thereof and discharge compacted cut grass from an outlet thereof.

39. The grass compactor of claim 41, wherein the grass compactor further comprises a motor to drive the compaction conveyor.

40. The grass compactor of claim 41, wherein the mounting structure includes an electrical connector for electrical connection with a battery of the lawn mower to power the motor.

41. The grass compactor of claim 41, wherein the compaction conveyor is a screw conveyor that has a narrowing tapered diameter along its length that narrows toward the outlet.

42. The grass compactor of claim 41, wherein the feed hopper is disposed above the compaction conveyor to gravity feed the cut grass to the compaction conveyor.

43. The grass compactor of claim 41, wherein the grass compactor further comprises a channel for transporting cut grass from the inlet to the feed hopper.

44. The grass compactor of claim 43, wherein the channel is upwardly inclined from the inlet to the feed hopper.

45. The grass compactor of claim 43, wherein the channel comprises an air vent in the region of, near, or adjacent the feed hopper.

46. A lawn mower comprising the grass compactor of claim 41.

47. The lawn mower of claim 46, wherein the lawn mower is an electric lawn mower.

48. An electric push lawn mower comprising:
a lawn mower body housing a rotatable blade and an electric motor operatively connected to the rotatable blade to rotate the rotatable blade; and
a handle portion extending from the lawn mower body for a user to push and/or pull the lawn mower during operation;
wherein the lawn mower body further comprises a transport chute arranged above the rotatable blade and configured to receive cut grass from an underside of the lawn mower body and to transport the cut grass to a grass catcher.

49. The electric push lawn mower of claim 48, wherein the transport chute is integrally formed with the lawn mower body.

50. The electric push lawn mower of claim 48, wherein the transport chute comprises an inlet that opens into the underside of the lawn mower body and an outlet for discharging cut grass into the grass catcher.

51. The electric push lawn mower of claim 48, wherein the transport chute is substantially cylindrical in internal cross-section and has a longitudinal axis that is substantially parallel to an axis of rotation of the rotatable blade.

52. The electric push lawn mower of claim 48, wherein the transport chute tapers along the longitudinal axis narrowing in a direction away from the rotatable blade.

53. The electric push lawn mower of claim 48, wherein the transport chute has an outlet portion, and the outlet portion extends in a direction that is substantially perpendicular to the longitudinal axis.

54. The electric push lawn mower of claim 53, wherein the outlet portion includes a feed hopper, the feed hopper configured to receive the cut grass and to feed the cut grass to a grass compactor.

55. (canceled)

56. The electric push lawn mower of claim 48, wherein the motor is a brushless DC motor.

57. The electric push lawn mower of claim 48, wherein the motor is generally of cylindrical shape having a diameter of from about 20 mm to about 80 mm.

58. The electric push lawn mower of claim 48, wherein the motor is generally of cylindrical shape having a length of from about 60 mm to about 140 mm.

59. (canceled)

60. The electric push lawn mower of claim 48, wherein the transport chute is vertically oriented relative to the electric push lawn mower during use.
